(19) United States
(12) Patent Application Publication
(10) Pub. No.: US 2010/0111163 A1
(43) Pub. Date: May 6, 2010

(54) Method for p-domain frame level bit allocation for effective rate control and enhanced video encoding quality

(76) Inventors: Hua Yang, Plainsboro, NJ (US); Jill MacDonald Boyce, Manalapan, NJ (US)

Correspondence Address: Robert D. Shedd, Patent Operations;THOMSON Licensing LLC, P.O. Box 5312, Princeton, NJ, 08543-5312, US

(21) Appl. No.: 12/311,372

(22) PCT Filed: Sep. 28, 2007
(86) PCT No.: PCT/US2007/020929

§ 371 Date: Dec. 22, 2009

Related U.S. Application Data
(60) Provisional application No. 60/848,254, filed on Sep. 28, 2006.

(51) Int. Cl. H04N 11/04

(52) U.S. Cl. 375/240.01; 375/E07.001

(57) ABSTRACT

A method is claimed for encoding a group of pictures at a target bit rate. A pre-analysis procedure (105) is performed for each frame in the group of pictures as to develop a series of parameters. A pre-processing procedure is then performed for a frame selected from said group of pictures (115), so that the parameters associated with the selected frame are updated while the parameters associated unencoded frames from the group of pictures remain the same. These two sets of parameters are then used to determine an allocated bit rate (125) for the frame such that when the frame is actually encoded, the allocated bit rate is reserved for the encoding operation. The allocated bit rate and the target bit rate for the group of pictures may be different, and the quantization level associated with the allocated bit rate may be different than the quantization level associated with the actual bit rate used to encode the frame.

### CROSS-REFERENCE TO RELATED APPLICATIONS

This application claims the benefit of U.S. Provisional Application Ser. No. 60/848,254, filed Sep. 28, 2007, which is incorporated by reference herein in its entirety.

### TECHNICAL FIELD

The present principles relate generally to video encoding and, more particularly, to a method and apparatus for encoding video to meet a specified average bit rate.

### BACKGROUND

In a video coding system, rate control plays an important role on rendering a good overall video coding performance. In practice, different application scenarios may pose different types of rate control problems, which can be roughly categorized as either constant bit rate (CBR) or variable bit rate (VBR) rate control. In real-time video-over-network applications, e.g. video-on-demand, video broadcasting, video conferencing, and video telephony, etc., input video signals usually have to be coded at a constant average bit rate, due to the limited channel bandwidth, and thus, CBR rate control is required. On the other hand, for the various off-line video compression applications, e.g. compressing home videos or movies into DVDs, etc., there is no stringent constant bit rate restriction, as the only limit is the overall storage space. In this case, VBR coding is allowed, which renders a less challenging rate control task than CBR coding.

In a practical video streaming system, buffering is necessary at the decoder side to absorb bit rate variations across frames and variable transmission delays, and thus, ensure smooth and continuous play-out of decoded video signals. If the bit rate variations of different frames are too large, the buffer may be underflow or overflow. In either case, continuous and smooth video play-out cannot be maintained any more. Hence, the objectives of a good CBR rate control scheme are mainly three folds: (i) to achieve average target bit rate; (ii) to meet buffer constraints; (iii) to maintain consistent video quality. Among them, rate; (ii) to meet buffer constraints; (iii) to maintain consistent video quality. Among them, the first two objectives are more urgent for the system, and hence are generally of higher priority in practice.

Video streaming applications can be further classified as either delay-sensitive or delay-insensitive. Interactive two-way streaming applications, e.g. video conferencing or video telephony, have very stringent delay requirement (usually less than several hundreds of milliseconds), and hence, yields a small size of decoder buffer. In this case, after achieving the average bit rate and meeting buffer constraints, there is very limited scope for consistent coded video quality. On the other hand, in one-way streaming applications, e.g. video-on-demand or video broadcasting, several seconds or several tens of seconds delay is usually allowable, and a large size of buffer can be employed. In view of all of these considerations, there is a need to produce a video encoder that can provide a Group of Pictures composed of a series of video frames that have an overall average bit rate (CBR), while not having the relative quality of such frames suffer to achieve such a requirement.

### SUMMARY

These and other drawbacks and disadvantages of the prior art are addressed by the present principles, which are directed to a method and apparatus for reusing available motion information as a motion estimation predictor for video encoding.

According to an aspect of the present principles, there is provided an encoder that makes use of a pre-encoding and pre-analysis when analyzing a group of pictures of frames that will be encoded. The result of such steps for each group of pictures has the same or similar overall average bit rate, while the frames in such group of pictures will have variable bit rates allocated and reserved for the encoding of such frames.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows a block diagram of an exemplary process of performing a pre-analysis and pre-processing steps for encoding a group of pictures, in accordance with an embodiment of the present principles of the invention;

FIG. 2 shows a flowchart of an exemplary process of performing a pre-analysis operation on a group of pictures, in accordance with an embodiment of the present principles of the invention;

FIG. 3 shows a flowchart of an exemplary process of performing a frame-level bit allocation based on p-domain and distortion modeling, in accordance with an embodiment of the present principles of the invention;

FIG. 4 shows a flowchart of an exemplary process which encodes each group of pictures with an constant bit rate, while the frames in such a group of pictures have variable bit rates, in accordance with an embodiment of the present principles of the invention;

FIG. 5 shows a block diagram for an exemplary video encoder with a pre-processing element, to which the present principles may be applied, in accordance with an embodiment of the present principles;

### DETAILED DESCRIPTION

The principles of the invention can be applied to any intra-frame and inter-frame based encoding standard. In addition, though-out the specification the terms “picture” and “frame” are used synonymously. That is, the term frame or picture represents the same thing.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

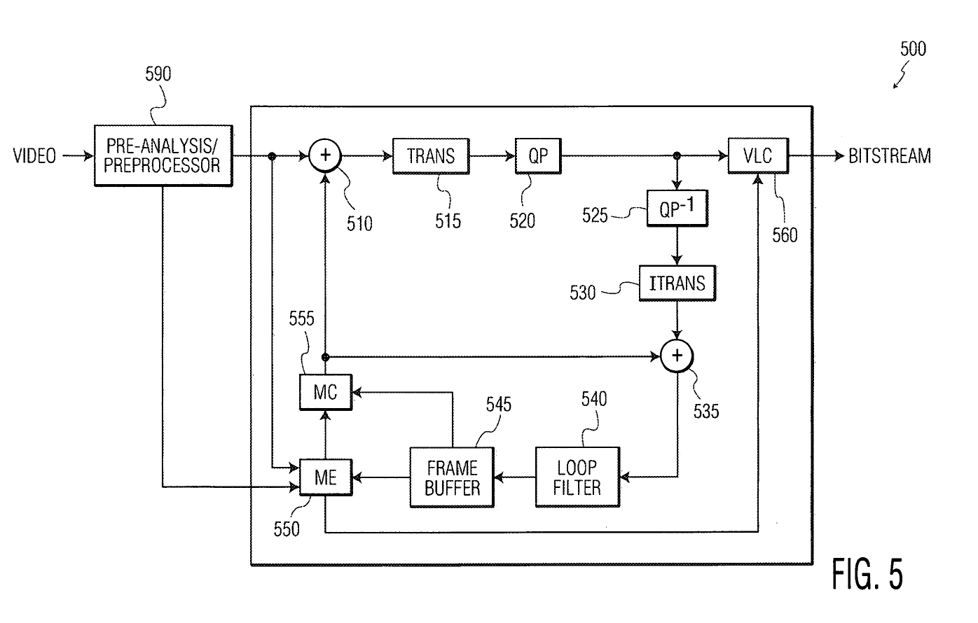

The principles of the present invention are to be practiced as shown in FIG. 5 with an exemplary video encoder implemented as hardware, in software, or as a combination thereof with a pre-analysis/pre-processing element as indicated generally by the reference numerals 500 and 590, respectively. The pre-analysis/pre-processing element 590 performs the various pre-processing and pre-analysis operations described below regarding the operation of various elements of the invention.

The video encoder 500 includes a combiner 510 having an output connected in signal communication with an input of a transformer 515. An output of the transformer 515 is connected in signal communication with an input of a quantizer 520. An output of the quantizer is connected in signal communication with a first input of a variable length coder (VLC) 560 and an input of an inverse quantizer 525. An output of the inverse quantizer 525 is connected in signal communication with an input of an inverse transformer 530. An output of the inverse transformer 530 is connected in signal communication with a first non-inverting input of a combiner 535. An output of the combiner 535 is connected in signal communication with an input of a loop filer 540. An output of the loop filter 540 is connected in signal communication with an input of a frame buffer 545. A first output of the frame buffer 545 is connected in signal communication with a first input of a motion compensator 555. A second output of the frame buffer 545 is connected in signal communication with a first input of a motion estimator 550. A first output of the motion estimator 550 is connected in signal communication with a second input of the variable length coder (VLC) 560. A second output of the motion estimator 550 is connected in signal communication with a second input of the motion compensator 555. A second output of the motion compensator is connected in signal communication with a second non-inverting input of the combiner 535 and with an inverting input of the combiner 510. A non-inverting input of the combiner 510, a second input of the motion estimator 550, and a third input of the motion estimator 550 are available as inputs to the encoder 500. An input to the pre-processing element 590 receives input video. A first output of the pre-analysis/pre-processing element 590 is connected in signal communication with the non-inverting input of the combiner 510 and the second input of the motion estimator 550. A second output of the pre-analysis/pre-processing 590 is connected in signal communication with the third input of the motion estimator 550. An output of the variable length coder (VLC) 560 is available as an output of the encoder 500. As, the encoder in FIG. 5 represents an exemplary encoder, it is to be understood that pre-analysis/pre-processing element 590 may be separated into several additional element's and may be coupled to other elements of the encoder.

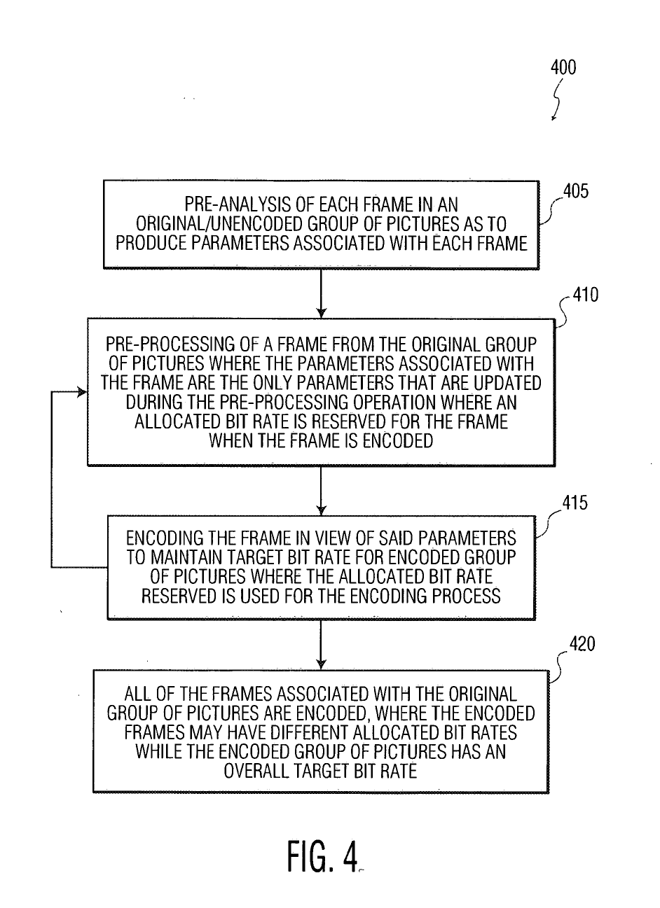

Before the specific processing elements of the invention are presented, with a corresponding explanation for why such elements are utilized in accordance with the invention, FIG. 4 details a flowchart of an exemplary encoding method 400 of the present invention which is used to produce constant bit rate groups of pictures (inter-GOP CBR), while the frames in each group of pictures are encoded with different bit rates (intra-frame VBR). Encoding method 400 represents an overall view of the encoding analysis/encoding processes used in this invention.

Step 405 introduces the issue of performing a pre-analysis of each frame in an original group of frames that is to be encoded. As explained later, an embodiment of the present invention utilizes a ρ-domain rate model which assumes a common distortion for each frame in the group of pictures. The result of a pre-analysis operation produces parameters such as ρ-QP and D′-QP which are utilized later when such frames are encoded as to produce an encoded group of pictures.

Step 410 introduces a pre-processing step where a particular frame from the original group of pictures is analyzed as to update the ρ-QP and D′-QP associated with the particular frame before it is encoded. That is, the ρ-QP and D′-QP associated with the frames that come after the current frame being encoded are from the pre-analysis phase, while the ρ-QP and D′-QP of the current frame are updating during this step, so that an allocated bit rate is reserved for the encoding of the current frame such that a overall target bit rate may be met for an encoded GOP. This means, is that the allocated bit rate, for example, of an I frame/picture (or a complex P frame/picture) would have more bits reserved for an encoding operation than an I or P frame/picture of a simple complexity. This also means that for a particular group of pictures, the allocated bit rate for each frame may change from frame to frame so that the bit rate allocated for a first frame will be different than the bit rate allocated for the encoding of a second frame.

When a frame is encoded, the encoder has to consider the bit rate consumed in the encoding of the previous and current encoded frames, as to provide that the group of pictures, when encoded, will be at a target bit rate (CBR). Hence, the ρ-QP and D′-QP parameters are hence adjusted so that the target bit rate of a encoded GOP is met where the allocated bit rate (which affects the quantization level used for encoding a frame) will vary from frame to frame of the GOP. This means that the encoder has to reserve the allocated bit rate for each frame so that the overall target bit rate may be met.

In step 415, the current frame is encoded, where the allocated bit rate is associated with the current frame. It is to be understood however the when the current frame is actually encoded, an operation such as macroblock-level bit allocation is used to determine the actual quantization level used to encode such a frame (where a quantization level associated with the allocated bit rate reserved for the frame not be the same quantization level used to encode the particular frame). The purpose of the invention however sets aside an allocated bit rate for the actual encoding process, so that the system pre-guesses which frames will require more bits for encoding (at a first quantization level) and which frames will require few bits associated with the allocated bit rate for the frame, where steps 410 and 415 are repeated for each successive frame in the original GOP, such that the target bit rate for the encoded GOP is met (as in step 420 where all of the frames of the original GOP are encoded).

The invention may be practiced where only selected frames in a GOP are to be encoded, and the above explained processes are performed for only those frames. For example, it may be determined that although an original GOP may be configured for delivery at 30 frames a second, the actually delivery of the GOP (when encoded) may be for a system that can only decode video at 15 frames a second. Hence, there may be an additional operation of pre-analysis where the frames in an original GOP are selected at certain intervals, or that specific frame types “I frames/pictures” are selected over other frame types “P frames/pictures”.

For implementing the desired results above, an embodiment of the present invention utilizes a solution for a frame-level bit allocation (FBA), based on p-domain rate and distortion (RD) modeling. The presented FBA scheme lies in its effective reduction on reference and coding mode mismatch via simplified encoding, the new efficient and accurate distortion model, the low complexity optimization algorithm, and the properly designed model parameter updating schemes. Comparing with other existing FBA solutions, the proposed scheme achieves a better complexity vs. performance trade-off. With moderate complexity increase, the proposed FBA scheme achieves much more effective rate control than the existing variance-based FBA scheme does, and yields significant improvement on perceptual video coding quality.

The following embodiments of the present invention target one-way non-interactive video streaming applications, although such principles of the invention can be used in other video delivery applications either using two-way, and/or interactive capabilities. Especially, such other delivery applications can be used if sufficient buffer size and pre-loading time of delivered content are assumed where buffer/memory constraints are not a problem in the decoding/delivery of a video stream.

In practice, rate control is conducted at both the frame-level and the macro-block (MB)-level. The total coding bit rate is first allocated at the frame-level to specify how much bit a particular frame is going to take for its encoding, and then, the bit is further allocated to different MBs of the frame. As a result, the quantization scale of each MB will be determined for actual encoding of the MB. This invention describes a complete solution on frame-level bit allocation (FBA).

Specifically, this invention presents a p-domain RD model based FBA solution. The present invention is built (and improves on) the concepts from the existing p-domain rate model the article, “Object-level bit allocation and scalable rate control for MPEG-4 video coding,” Proc. Workshop and Exhibition on MPEG-4, pp. 63-6, San Jose, Calif., June 2001 written by Z. He, Y. Kim, and S. K. Mitra and a new effective distortion model presented in “An analytic and empirical hybrid source coding distortion model with high modeling accuracy and low computation complexity”, PCT Application US 2007/01848, filed on Aug. 21, 2007 by H. Yang and J. Boyce, to estimate the actual RD characteristics of a frame. To mitigate the impact of reference and coding mode mismatch and thus improve the operational RD modeling accuracy, a carefully designed simplified encoding algorithm is applied to collect RD data of all the frames in a group of pictures (GOP), via a pre-analysis process prior to coding of the GOP. As for the current frame, its RD data used for FBA is re-calculated in a pre-process procedure prior to coding of the frame, when its exact reference frame is available. Based on the frame-level RD data, an efficient optimization scheme is proposed to solve the FBA problem, where assuming all the frames of the GOP will be coded with the same level of distortion, the objective is to find the minimum constant distortion, subject to the constraint of target total bit rate. Besides, unlike any other p-domain FBA approaches, the proposed scheme adopts a uniquely designed approach to separately update the involved RD model parameters for pre-analysis and pre-process data. Finally, via extensive experiment, the inventors recognized that the proposed FBA scheme consistently outperforms the existing variance-based FBA approach with significant improvement on the overall perceptual video coding quality.

In terms of FBA, existing schemes can be roughly categorized as either a heuristic scheme or an RD efficiency based scheme. Most heuristic FBA schemes can be regarded as complexity measure based schemes which are mostly originated from a simple yet useful intuition, that is, to allocate more bits to complicated frames, and fewer bits to simple ones, such that all the frames bear similar coding quality and the total bit budget is rightly used up at the same time. In these schemes, a certain quantity, e.g. the mean-absolute-difference (MAD) (see B. Xie and W. Zeng, “A sequence-based rate control framework for constant quality video,” IEEE Trans. Circuits Syst. Video Technol., vol. 16, no. 1, pp. 56-71, January 2006) or variance (see I.-M. Pao and M.-T. Sun, “Encoding stored video for streaming applications,” IEEE Trans. Circuits Syst. Video Technol, vol. 11, no. 2, pp. 199-209, February 2001) of the prediction residue frame, or the quantization parameter (QP) of a frame in CBR coding (see P. H. Westerink, R. Rajagopalan, and C. A. Gonzales, “Two-pass MPEG-2 variable-bit-rate encoding,” IBM J. Res. Develop., vol. 43, no. 4, pp. 471-488, July 1999), is used to measure the coding complexity of a frame, and bits is proportionally allocated to each frame, according to its complexity value.

On the other hand, instead of heuristically measuring the coding complexity, RD FBA schemes directly estimate RD functions of a frame and then apply these RD data in an algorithm to find out the an FBA solution. RD efficiency based FBA schemes generally render more effective rate control and better overall video coding quality than the heuristic approaches, and thus is more preferable in practice, whenever its increased complexity is affordable (e.g. due to low complexity implementation (see L.-J. Lin and A. Ortega, “Bit-rate control using piecewise approximated rate-distortion characteristics,” IEEE Trans. Circuits Syst. Video Technol., vol. 8, no. 4, pp. 446-59, August 1998), or due to offline video coding (see Y. Yue, J. Zhou, Y. Wang, and C. W. Chen, “A novel two-pass VBR coding algorithm for fixed size storage applications,” IEEE Trans. Circuits Syst. Video Technol, vol. 11, no. 3, pp. 345-36, March 2001; J. Cai, Z. He, and C. W. Chen, “Optimal bit allocation for low bit rate video streaming applications,” Proc. ICIP 2002, vol. 1, pp. 22-5, September 2002) which poses no strict complexity constraint). This invention is also focused on RD efficiency based FBA. Next, some key features of the present invention are disclosed over the prior art.

In RD optimized FBA, the first critical issue is how to accurately estimate the RD functions of each frame, for which a large variety of different RD models have been proposed so far. In terms of rate modeling, the p-domain rate model proposed in the He, Kim, and Mitra article renders high modeling accuracy with low computation complexity, and thus, is a superior method as compared to the other existing rate models. However, most of existing applications of the accurate p-domain rate model are focused on MB-level rate control. This invention presents a scheme to apply the model in frame-level rate control. Along with the existing MB-level schemes, a complete p-domain rate modeling based rate control framework can be achieved. To the best of our knowledge, the only published work on a similar topic is from Cai, He, and Chen article where, targeting offline video compression applications for DVDs and movies, p-domain RD models are applied for optimized FBA in VBR coding of a whole video sequence. In contrast, our scheme targets real-time video streaming applications with CBR rate control, which renders much more strict limits on encoding delay and complexity.

In terms of source coding distortion modeling, existing RD efficiency based FBA schemes adopt either a QP-based or p-based analytic models (see the He, Kim, Mitra article; N. Kamaci, Y. Altunbasak, and R. M. Mersereau, “Frame bit allocation for the H.264/AVC video coder via Cauchy-density-based rate and distortion models,” IEEE Trans. Circuits Syst. Video Technol., vol. 15, no. 8, pp. 994-1006, August 2005; A. Ortega, K. Ramchandran, and M. Vetterli, “Optimal trellis-based buffered compression and fast approximations,” IEEE Tran. Image Processing, vol. 3, no. 1, pp. 26-40, January 1994) or an interpolation-based empirical model, as disclosed in the Lin and Ortega article. In the model disclosed in the Yang and Boyce patent application, a more accurate analytic and empirical hybrid distortion model is proposed, which still yields low computational complexity due to its fast table look-up calculation. In the discussed embodiments of the present invention, this superior distortion model in our proposed RD optimized FBA solution is adopted, which renders improved performance over other less accurate models.

With accurate source coding RD models, one may accurately estimate the R-QP and D-QP relationships of a certain frame, given its prediction reference frame, and coding modes of all the MB's (including both motion vectors and MB or block coding modes). However, in practical FBA problems, RD functions of a frame have to be estimated prior to the encoding process. Due to the motion compensated predictive video coding framework, one can never know the exact reference and coding modes of a certain frame, without actually encoding all its previous frames. Hence, inevitable mismatch exists between the reference and coding modes assumed in FBA and those resulted from actual encoding, which will definitely compromise the actual operational estimation accuracy of the basic RD models.

In fact, this mismatch issue has long been recognized as the inter-frame dependency issue of RD functions. To accurately account for the impact of inter-frame dependency, some existing schemes resort to exhaustive encoding (see A. Ortega, K. Ramchandran, and M. Vetterli, “Optimal trellis-based buffered compression and fast approximations,” IEEE Tran. Image Processing, vol. 3, no. 1, pp. 26-40, January 1994) or exhaustive modeling (as explained in the Lin and Ortega article) for all the possible QP combinations of the frames, which incur prohibitive computation complexity. As another extreme for low complexity, some schemes simply take the original video frames as reference frames in pre-analysis (see the Yue/Zhou/Wang/Chen article), which, however, may greatly degrade the RD estimation accuracy, and hence, the consequent rate control performance. To better tradeoff complexity with performance, some solutions conduct pre-analysis via one single pass of encoding (see the Cai, He, Chen article; Y. Sermadevi and S. Hemami, “Linear programming optimization for video coding under multiple constraints,” Proc. DCC 2003). To effectively compensate the mismatch impact, the pass of pre-analysis encoding could be either CBR coding with the target bit rate (see the Sermadevi/Hemami article) or using a certain fixed QP for all the frames (see the Cai/He/Chen article). In this invention, instead of using one pass full encoding, we develop an approach of simplified encoding with fixed QP for reference and coding mode mismatch compensation, where only P16×16 (or I16×16) mode is applied in P-frame (or I-frame) coding, and no entropy coding is involved. In practice, full encoding can be simplified to various different extents with more or less coding options included. Our simplified scheme involves a certain set of coding options, which proves to represent a good complexity vs. performance trade-off, as justified with extensive experiment results. Furthermore, after thoroughly investigating the QP mismatch impact, we develop an effective way to select the level of fixed QP. Hence, the principles of the present invention disclose a more effective solution on pre-analysis mismatch compensation.

After calculating the RD data of each frame, one can then use them to optimize FBA. In terms of improvement criterion, a commonly adopted scheme is to minimize average MSE distortion (see either the Lin/Ortega or Yue/Zhou articles) However, minimizing average distortion does not guarantee low quality variations across frames, which is also important as for good perceptual video quality. Hence, some more advanced schemes choose to minimize either the maximum distortion (see G. M. Schuster, G. Melnikov, and A. K. Katsaggelos, “A review of the minimum maximum criterion for optimal bit allocation among dependent quantizers,” IEEE Trans. on Multimedia, vol. 1, no. 1, pp. 3-17, 1999) or the combination of the average and variation of distortion (see the Lin/Ortega article). In the present invention, a case of a constant level of distortion is assumed for all the frames in an optimization approach, and a fast searching algorithm combining gradient descent search and bisectional search is developed to find the minimum distortion level while satisfying the target bit rate constraint. Comparing with existing optimization algorithms, our scheme is not only of lower complexity, but also more directly targets constant quality maximization, and thus, is more applicable in practical video streaming systems for improved perceptual video coding quality.

The proposed FBA solution also lies in its uniquely designed RD model parameter updating scheme, where parameters of pre-analysis and pre-process models are separately maintained with sliding windows of two different sizes. In practice, video signals may contain unusual frames, e.g. all-white frames or completely still frames, whose coding consumes very few bits, and should not be included in model parameter updating. Hence, the present invention involves effective unusual frame identification and some other exception treatments to prevent various system failures and keep the whole system running smoothly in practice.

In order to implement the concepts described for FIG. 4, the present invention proposes a ρ-domain RD FBA solution for effective rate control. Our scheme targets one-way non-interactive video streaming applications, which usually does not have a strict delay constraint. Herein, we assume a sufficient buffer size, and thus, no buffer constraint is involved. We assume a whole GOP is available before coding, which incurs an encoding delay of one GOP. For a certain specified target bit rate, a CBR coding across different GOP's and VBR coding within a single GOP is assumed, which means that each GOP has the same total bit budget (determined from the target average bit rate), and FBA is conducted over all the frames within a GOP.

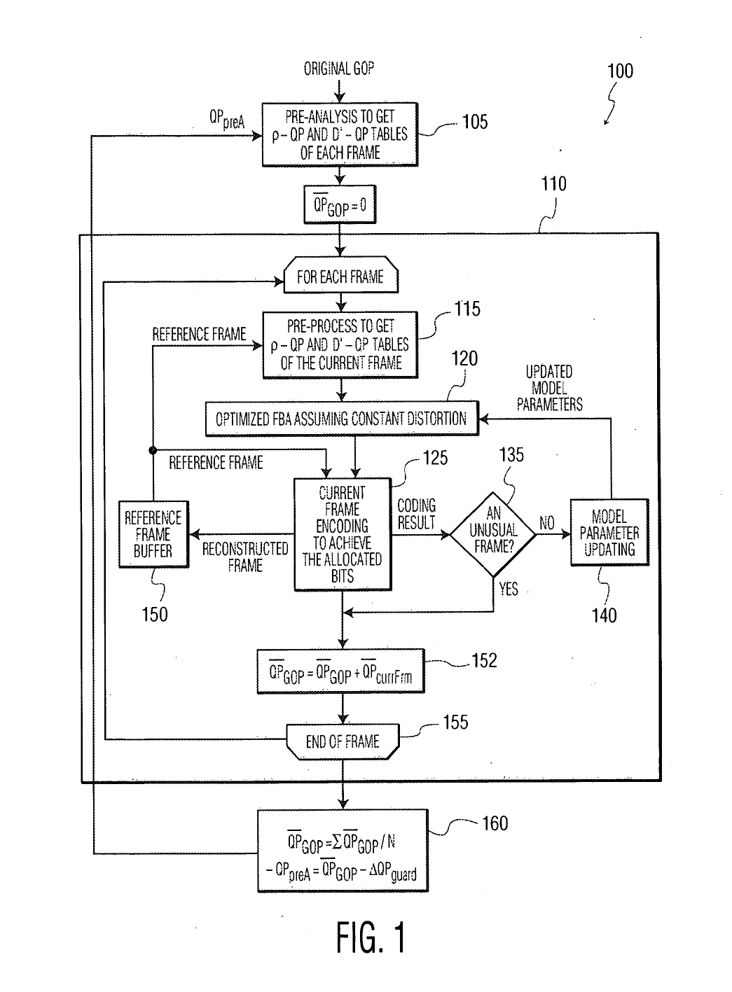

The encoding process 100 of an original GOP composed of pictures to be encoded is illustrated in FIG. 1. With one GOP of original video frames available, a pre-analysis process 105 is first initiated to collect RD modeling data from each frame, using our proposed simplified encoding approach. Scene change detection is also realized in pre-analysis. If there is no scene change inside a GOP, the GOP will be coded with the 1^{st} frame being I-frame and the remaining frames being P-frames. Otherwise, the scene change frames will be coded as I-frames as well. After pre-analysis in step 110, the actual encoding of the original GOP is conducted frame by frame. Before each P-frame coding, RD data of the current frame is re-collected via simplified encoding. Because at this point, the exact prediction reference frame is available. Without reference mismatch, more accurate RD estimation may be achieved. We call this operation pre-process in step 115. Next, in step 120 optimized FBA is executed over all the remaining frames, and each frame is assigned a certain amount of bits. Then, with the help of MB-level rate control, the current frame is actually encoded to achieve the assigned bit budget. Based on its actually consumed bits, the budget is updated for the remaining frames in the GOP. The whole process of step 110 of pre-process, FBA, and encoding is then repeated for the next frame, and so on.

Before we go into details of each module, let us first take a look at the adopted RD models in the proposed FBA scheme. For rate modeling, we adopt the p-domain model proposed in the He/Kim/Mitra article which is defined as follows.

R(QP)=θ(1−ρ(QP))+C (1)

Here, ρ(QP) represents the ratio of zero quantized coefficients over all the coefficients, after quantization with QP. C denotes all the other overhead bits other than the coefficient coding bits, including: picture header bits, macro block header bits, coding mode bits, and motion vector (MV) bits. θ is another model parameter (see the article), independent from QP. Note that ρ has a one-to-one mapping with QP. In the He/Kim/Mitra article, it was shown that R has a very strong linear relationship with ρ, which guarantees the high modeling accuracy of the model. Its superior performance was also verified in our extensive experiment.

Our distortion model is the hybrid model disclosed in the Yang/Boyce patent application defined as

$$\begin{matrix}D ( QP ) ≅ {D}_{nz} ( QP ) + {D}_{z} ( QP ) \\ = ( 1 - ρ ( QP ) ) \cdot \frac{1}{12} {Q ( QP )}^{2} + \\ \frac{1}{A \cdot ρ ( QP )} {\sum }_{i = 1}^{A ρ ( QP )} {Coeff}_{z , i}^{2} ( QP ) .\end{matrix} \qquad ( 2 )$$

Herein, A denotes the total number of pixels in a frame. Q denotes the quantization step size related with QP. In H.264, QP ranges from 0 to 51, and the relationship between QP and Q is

Q≅2^{(QP-4)/6}. (3)

Coeff_{z}(QP) denotes the magnitude of a coefficient that will be quantized to zero with QP. We can see that in this distortion model, the overall MSE distortion is divided into two parts: distortion contribution of non-zero quantized coefficients D_{nz}(QP) and that of zero quantized coefficients D_{z}(QP). Modeling approximation only happens in calculating the distortion of non-zero quantized coefficients, where uniformly distributed quantization error is assumed. The distortion of zero quantized coefficients is exactly calculated without any approximation. The most remarkable advantage of the model is that exact calculation of D_{Z}(QP) can be conducted with a fast table look-up approach, which only incurs marginal complexity increase. Hence, the model achieves higher accuracy than existing models, while still maintaining low complexity.

In practice, we found that reference and coding mode mismatch may more seriously degrade the performance of distortion modeling than it does for rate modeling. Hence, an additional model parameter α is introduced to compensate the mismatch effect, as shown below. Herein, D′ denotes the distortion estimate from (2).

D(QP)=α·D′(QP). (4)

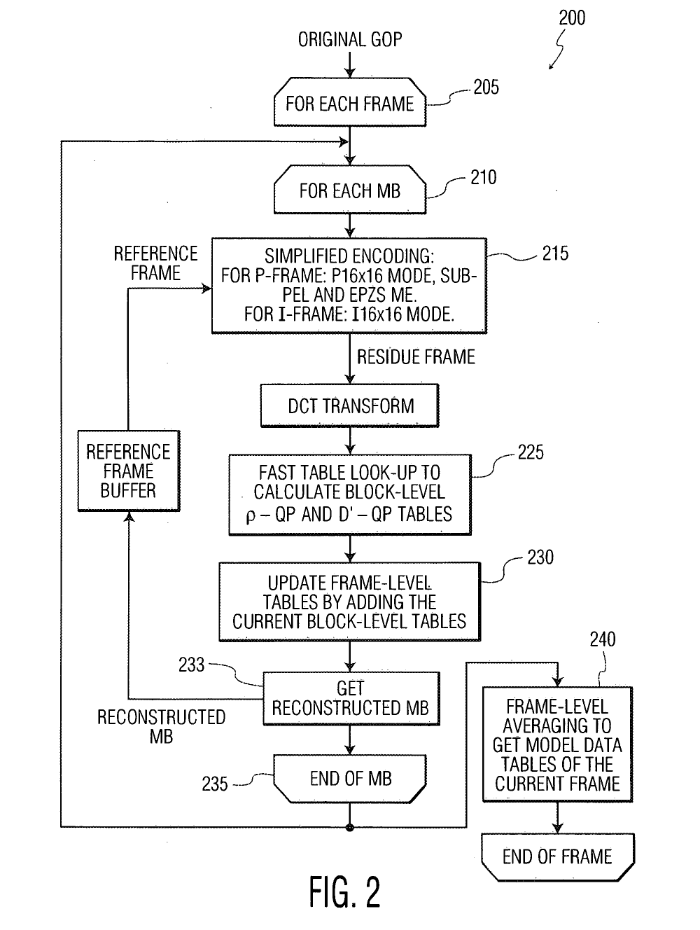

The purpose of pre-analysis is to calculate the ρ-QP and D′-QP tables for each frame of the GOP, which will be later on used in optimized FBA. The block diagram of our proposed pre-analysis scheme 200 is shown in FIG. 2 (refer back to step 105). To effectively mitigate the impact of reference and coding mode mismatch on RD modeling, a simplified encoding approach for pre-analysis uses only one single MB coding when coding a frame, i.e. P16×16 or I16×16 mode for P-frame or I-frame, respectively.

Beginning with a frame, as in step 205, a full encoding process of H.264, a variety of coding modes need to be checked for each MB (step 210, step 215), e.g. P16×16, P16×8, P8×16, P8×8, P8×4, P4×8, P4×4, Skip, I16×16 and I4×4, which incurs a significant amount of complexity. Existing pre-analysis schemes employ either full encoding (see Cai/He/Chen) or no any encoding at all (see Yue/Zhou/Wang/Chen). In the present invention, a good balance between the two extremes is used, which renders a better trade-off between complexity and modeling accuracy. Through extensive experiments, it was determined: (i) Using only P16×16 or I16×16 mode does not sacrifice much on modeling accuracy, as compared to checking with all the legitimate modes; (ii) Sub-pixel motion estimation (ME) is necessary, as full-pixel ME yield poor modeling performance; (iii) Enhanced predictive zonal search (EPZS) ME achieves accuracy close to that of full search ME, and is much better than that of the lower complexity ME scheme of log search; (iv) With the ME search range of actual encoding being 128, good search range for pre-analysis could be 64, but not 32. These useful results finalize the corresponding settings of the proposed pre-analysis scheme.

Note that in our pre-analysis process, entropy coding is not involved, as we only need to collect the ρ-QP data for rate modeling. Other than that, our scheme does require quantization, inverse transform, and inverse quantization, etc. to get a reconstructed frame for prediction reference. Herein, one needs to decide how to select the QP for quantization. Similarly in the Cai/He/Chen article, it is assumed that all the frames of a GOP use a fixed QP for pre-analysis. In this case, the original reference mismatch problem becomes the QP mismatch problem, for which we thoroughly investigated its impact on the performance of our adopted RD models. In experiment, for many various video sequences, we apply QP=25, 35, 45 for actual encoding, and encoding QP+5 or encoding QP−5 for pre-analysis. Experiment results show that: in terms of rate modeling, underestimated QP (i.e. pre-analysis QP is less than actual encoding QP) is more preferable than overestimated QP, as with encoding QP+5, the rate modeling accuracy is much worse than that of encoding QP−5. As for distortion modeling, overestimated QP is better than underestimated QP. However, the performance degradation from underestimated QP is not very much. Furthermore, in practice, accurate rate modeling is of higher priority than that of accurate distortion modeling, as accurate rate control is always necessary to avoid system failure due to buffer overflow or underflow. Therefore, overall, with QP mismatch being inevitable, underestimated QP is more preferable than overestimated QP in pre-analysis. In our scheme, pre-analysis QP of the current GOP QP_{preA,currGOP} is determined by

QP_{preA,currGOP}= Q̅P̅_{prevGOP}−ΔQP_{guard}. (5)

Herein, “preA” stands for pre-analysis. Q̅P̅_{prevGOP} denotes the average QP of previous coded GOP. ΔQP_{guard} is a QP guardian gap to make QP_{preA,currGOP} be more likely underestimated than the actual encoding QP.

In our pre-analysis scheme, calculation of the ρ-QP and D′-QP tables (as in step 225) is conducted via fast table look-up, and thus, the whole calculation does not incur a significant increase of complexity. For reference convenience, the fast calculation algorithm is given below (which is performed for steps 225, 230 and 233). The method repeats such analysis for each macroblock in a frame using steps 210 to 235 until all such macroblocks of a picture are processed.

Block-level calculation: for each transformed block:

1. Initialization: ∀QP, ρ(QP)=0, D_{z}(QP)=0.

2. One-pass table look-up: for each coefficient Coeffᵢ:
1) Levelᵢ=|Coeffᵢ|.
2) QPᵢ=QP_level_Table[Levelᵢ]. QP_level_Table is a table, which indicates for each coefficient level the minimum QP that will quantize a coefficient of that particular level to be zero.
3) ρ(QPᵢ)=ρ(QPᵢ)+1, D_{z}(QPᵢ)=D_{z}(QPᵢ)+Coeffᵢ².

3. Summation: for each QP, starting from QPₘᵢₙ to QPₘₐₓ:

$$ρ ( QP ) = {\sum }_{qp = {QP}_{min}}^{QP} ρ ( qp ) , {D}_{z} ( QP ) = {\sum }_{qp = {QP}_{min}}^{QP} {D}_{z} ( qp ) .$$

From above, ρ and D_{Z} of all the QP's can be exactly calculated via one pass of QP_level_Table look-up over all the transform coefficients, and the incurred computation cost is fairly low. After obtaining {ρ(QP),D_{z}(QP)}_{QP} for all the blocks of the frame, one can respectively average these data to get the corresponding frame-level quantities (step 240), as shown below. Here, B denotes the total number of blocks in a frame.

Frame-level calculation: for each QP:

$$1 ) ρ ( \dot{Q} P ) = \frac{1}{A} \cdot {\sum }_{i = 1}^{B} {ρ}_{i} ( QP ) , \\ 2 ) If ρ ( QP ) > 0 , {D}_{z} ( QP ) = \frac{1}{A \cdot ρ ( QP )} {\sum }_{i = 1}^{B} {D}_{z , i} ( QP ) . \\ Otherwise , \\ {D}_{z} ( QP ) = 0. \\ 3 ) {D}^{′} ( QP ) can be then calculated with$$

$$ρ ( QP ) and {D}_{z} ( QP ) as in ( 2 ) .$$

Is it is noted that before encoding a P-frame (as in step 125 of FIG. 1), the previous frame to the P frame has already been coded, and hence, the actual reference is known. At this point, more accurate ρ(QP) and D′(QP) data can be calculated via pre-process of the frame (for step 115 of FIG. 1). The steps of P-frame pre-process is the almost the same as in pre-analysis, except that it does not require quantization and other reconstruction steps any more. Note that I-frame does not need pre-process, as it only involves intra-frame prediction.

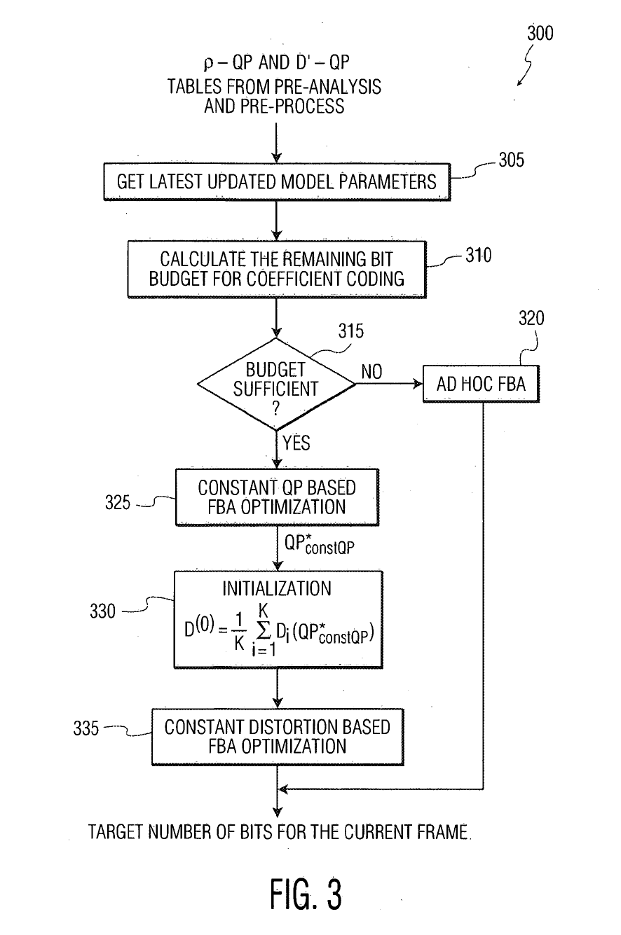

An exemplary embodiment of FBA algorithm (for step 120) is illustrated in FIG. 3 as FBA flowchart 300. The parameters from the pre-analysis/and pre-processing steps are used for a frame being encoded, where such parameters are obtained from a memory in step 305. Additionally, the encoder has to consider the bit budget remaining for the frames to be encoded in a GOP, in step 310, as to meet an overall bit rate for the encoded Group of Pictures. A consideration is made whether the remaining budget is sufficient or not (in step 315)

To achieve consistent video quality across different frames, our FBA scheme is directly focused on constant distortion minimization, where a fixed level of distortion is assumed for all the remaining frames of the GOP, and the algorithm searches for the minimum constant distortion that satisfies the target bit budget. Note that with simplified encoding effectively compensate the reference and coding mode mismatch in pre-analysis, one may assume that RD functions of different frames are independent, which leads to simple and straightforward searching schemes for global optimum. In contrast, assuming dependent RD functions, existing schemes suggest dynamic programming and iterative descent search, which either involves high computational complexity, or yields local optimal solutions.

Our constant distortion searching algorithm (325) involves both gradient descent search and bisectional search. In practice, another important factor that affects the searching complexity is the initial searching point. The search could be much faster, if a good starting point is used. In our scheme, the initial distortion level is the average distortion from the constant QP result, which gives a close approximation to the optimum constant distortion level. The searching process ends, when the relative error between achieved rate and target rate is below a certain threshold, or the number of iterations reaches a certain limit. Experiment results show that most of the time the search will end within 5˜6 iterations, which is fairly fast. The searching algorithm is described as follows. Herein, for conciseness, details of the common bisectional search are omitted. Also, note that R_{T arg et} represents the total bit budget on coefficient coding for all the remaining frames in the GOP, and the overhead bits are already excluded. This is simply because QP only affects the consumed bits on coefficient coding, but not the overhead bits.

Constant distortion based FBA algorithm:
1. Constant QP (step 325):

$${QP}_{constQP}^{*} = arg {min}_{QP} \vert {\sum }_{i = 1}^{K} {R}_{i} ( QP ) - {R}_{Target} \vert ,$$

where K denotes the number of remaining un-coded frames in the GOP, and Rᵢ is calculated as in (2) except without C. Fast bisectional search is used to search for the optimal QP.
2. Initialization (step 330): n=0,

$${D}^{( n )} = \frac{1}{K} {\sum }_{i = 1}^{K} {D}_{i} ( {QP}_{constQP}^{*} ) ,$$

where Dᵢ is calculated as in (4).
3. Given D⁽ⁿ⁾, for each un-coded frame i, use bisectional search to find the best QP, denoted by QP*ᵢ. Then, use these QP's to find corresponding Rᵢ(QP*ᵢ), and hence,

$${R}^{( n )} = \frac{1}{K} {\sum }_{i = 1}^{K} {R}_{i} ( {QP}_{i}^{*} ) .$$

4. ΔR⁽ⁿ⁾=(R⁽ⁿ⁾−R_{T arg et})/R_{T arg et}. If ΔR⁽ⁿ⁾ is less than a threshold (3% in our practice), go to 7.
5. If n=0, or if n>0 and ΔR⁽ⁿ⁾·ΔR⁽ⁿ⁻¹⁾>0, then search does not pass over the optimum D yet. Use gradient descent search, and update with D⁽ⁿ⁺¹⁾=D⁽ⁿ⁾·(1+ηΔR⁽ⁿ⁾). (In our practice, η=1.) If not, then search already passes over the optimum. Use bisectional search, and update with

$${D}^{( n + 1 )} = \frac{1}{2} ( {D}^{( n - 1 )} + {D}^{( n )} ) .$$

6. If n reaches the limit (in our practice, 10), go to 7. Otherwise, n=n+1, go to Step 3.
7. Search ends, and R_{currFrm}=A·(R₁⁽ⁿ⁾+C) is the total amount of bits for the current frame. Herein, A denotes the frame size. [Points 3-7 represent step 335]

To keep an algorithm run smoothly in practice, it is always necessary to identify those extreme situations for special treatments. As shown in FIG. 3, in the beginning of FBA, we check whether the remaining bit budget for coefficient coding is sufficient or not (step 315). If the ratio of the coefficient coding budget over the total budget is below a certain threshold (in our practice, 0.15), the budget is considered insufficient. In this case, optimized FBA is not necessary, and some simple ad hoc bit allocation scheme is more appropriate (step 320). Specifically when the bits for encoding run out or too little to meet a desired overall bit rate, more bits for picture header coding are allocated. If the remaining bits are still more than the picture header bits, the surplus bits will be evenly allocated to all the remaining frames.

How to effectively update the involved RD model parameters (i.e. θ and C in (2) and α in (4)) is another important issue that may critically affect the ultimate rate control performance. Since pre-analysis and pre-process render different modeling performance, their model parameters are separately calculated. In our scheme, we adopt the common sliding window approach, where the current parameters are updated from the past coding result within a certain sized window. Larger window sizes render better stability, but worse adaptability as well. Since the updated pre-analysis model parameters (from step 140) will be applied on all the remaining un-coded frames except the current frame, stability is of more importance than it is in pre-process. Therefore, in our solution, for pre-process, we update current frame parameters simply with those derived from the last frame coding result (the storage of the reference frame in step 150, while for pre-analysis, we really use sliding window updating, where the window size for P-frame parameter updating is 6, and that for I-frame updating is 3. The reason for a shorter window size of I-frame parameter updating is that, in practice, an I-frame is either the 1^{St} frame of a GOP or a scene change frame. Hence, if using the same window size as that for P-frame, the window will actually span over a much longer time distance, and thus, may not render sufficient adaptability.

As to be further explained, for each frame to be encoded in a GOP, the ρ-QP and D′-QP associated with a frame (steps 115, 120, 125, 135 and 140), as to use such a frame as a reference frame after it is encoded (after step 155), where such the encoded frame is reconstructed (see step 15), when the next frame in the GOP is to be pre-processed and encoded (steps 115, 120, 125, 135, and 140).

Another important measure for effective parameter updating is to exclude the coding results of those unusual frames from updating calculation (step 135). In practice, video signals may contain various types of unusual frames, such as all-white frames (especially in nowadays movie trailers), and completely still frames as in news showing score boards, stock information, etc., whose coding may consume extremely small amount of bits. Since characteristics of these frames cannot be generalized to other typical video frames, their coding results should also not be included in parameter updating. In our scheme, we identify a coded frame as an unusual frame, when any one of the following conditions is met: (i) if the ratio of coefficient coding bits over the total bits is below 15%; (ii) if the average variance of all the residue MB's of the frame is less than 0.1; (iii) if the average QP over all the MB's is below 10; (iv) if the resultant bit per pixel is less than 0.01.

The encoding process 100 repeats itself (as shown in 110) until all the frames of a particular GOP are encoded where the encoded GOP meets the overall required bit rate (CBR). In step 160, the QP_{preA,} is calculated by totaling the summation of all of the Q̅P̅_{GOP} determined in step 152. The QP_{preA,} calculated is then going to be determined as an average of the total summed Q̅P̅_{GOP}/N, and the resultant of the average quantization level has a guard value subtracted from it (see equation 5).

The disclosed FBA solution operates with a variety of testing video sequences, including both low motion, medium motion, and high motion sequences, both CIF and QCIF sequences), and at various concerned coding bit rates.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for encoding a video group of pictures at a target bit rate comprising the steps of:
deriving parameters for at least two unencoded frames from a group of pictures to be encoded;
updating a parameter associated with an frame to be encoded from said at least two frames; and
reserving an allocated bit rate for the encoding of said frame, where the allocated bit rate is determined from said updated parameter and the derived parameters associated with said unencoded frames from said at least two unencoded frames where the allocated bit rate reserved for encoding said frame is different from said target bit rate.

2. The method of claim 1, wherein said frame is encoded at a quantization level which is different than the quantization level associated with said allocated bit rate.

3. The method of claim 2, wherein said encoding quantization level is determined when performing a macroblock-level bit allocation operation on said frame.

4. The method of claim 1, comprising the additional steps of:
encoding a second frame from said at least two unencoded frames, where a second allocated bit rate is reserved for said encoding operation, and said second allocated bit rate is different from said allocated bit rate associated with said encoded frame.

5. The method of claim 1, wherein said bit rate allocated for said frame is determined by using a ρ-domain frame level bit allocation operation.

6. The method of claim 1, wherein said frame bit rate allocation is determined assuming that each frame has the same distortion factor.

7. The method of claim 6, wherein all of the frames associated with said group of pictures are analyzed such that bit rates are allocated for each frame when such frames are encoded as to meet the target bit rate of a group of pictures.

8. The method of claim 1, wherein said encoded group of pictures and a second encoded group of pictures has the same target bit.
